(19) United States
(12) Patent Application Publication
(10) Pub. No.: US 2014/0165411 A1
(43) Pub. Date: Jun. 19, 2014

(54) Electric Shears

(71) Applicant: Andreas Stihl AG & Co. KG, Waiblingen (DE)

(72) Inventor: Andreas Binder, Esslingen (DE)

(73) Assignee: Andreas Stihl AG & Co. KG, Waiblingen (DE)

(21) Appl. No.: 14/108,500

(22) Filed: Dec. 17, 2013

(30) Foreign Application Priority Data
Dec. 19, 2012 (DE) 10 2012 024 838.5

(51) Int. Cl. A01G 3/037

(52) U.S. Cl. CPC A01G 3/037
USPC 30/228

(57) ABSTRACT

Electrical shears have a housing with an electric drive motor arranged in the housing. A motor shaft is connected to the drive motor. Blades are provided and at least one of the blades is connected to the motor shaft. The motor shaft acts on the at least one blade for opening or closing the blades. A manual actuating member with a guide member is guided in a translatory motion, wherein the guide member has a length extending in a direction of a straight actuating travel path of the manual actuating member. A control unit is provided that controls the drive motor as a function of an electric control signal, wherein the electric control signal represents a mechanical position of the manual actuating member.

### BACKGROUND OF THE INVENTION

The invention relates to electric shears, in particular shears for cutting branches, pruning vines, gardening and the like, comprising a housing with an electric drive motor having a drive shaft by means of which at least one blade of the shears is actuated for opening and closing and wherein the drive motor, as a function of an electric control signal, is controlled by a control unit, wherein the electric control signal represents a mechanical position of a manual actuating member of the shears.

U.S. Pat. No. 5,002,135 discloses shears for pruning that are provided with a housing in which an electric drive motor is arranged. By means of the motor shaft of the drive motor a blade of the shears is actuated for opening and closing; for this purpose, the drive motor is controlled by a control unit as a function of an electric control signal.

The motor shaft drives a drive spindle that is connected with the blade. An actuating lever is pivotably secured on the drive spindle wherein between the drive spindle and the actuating lever a position sensor is arranged. When the operator suppresses the actuating lever, the position sensor is deflected from its rest position and, for compensation of the deflection, the electric motor is operated in such a rotational direction that the drive member on the drive spindle can compensate the deflection of the position sensor.

The actuating lever performs a pivot movement about its connecting axis so that between the finger of the operator and the actuating lever a relative displacement occurs that is perceived as uncomfortable. In addition, due to the type of control by means of the sensor integrated in the drive member, a relatively imprecise soft control action results and the operator perceives the actuation of the shears as impractical.

### SUMMARY OF THE INVENTION

It is an object of the present invention to further develop electric shears of the aforementioned kind such that the operator can perform with the actuating member a precise control of the blades with immediate feedback.

In accordance with the present invention, this is achieved in that the actuating member is guided so as to perform a translatory motion and is provided with a guide member that extends in the direction of a straight actuating travel path.

The translatory (linear) guiding action of the actuating lever or member corresponds to the movement of the trigger finger of the operator so that relative displacements between the actuating lever or member and the finger of the operator are substantially prevented. The translatory displacement of the actuating member requires only little space so that a slim configuration of the shears is possible. The housing can therefore be designed in accordance with ergonomic considerations of a handle without constructive limitations.

The translatory (linear) actuating travel of the actuating member and the closing angle of the blades are dependent from each other, preferably are directly dependent from each other. In this way, the operator, in any position of the actuating member, has an immediate visual feedback with respect to the position of the blades so that a direct precise cutting sensation is experienced. In a special configuration of the invention, the translatory (linear) actuating travel of the actuating member relative to the closing angle of the blades is approximately proportional. In this connection, slight deviations from a direct proportional characteristic line are permissible.

Since the movement of the actuating lever or member occurs on a straight path, the operator can determine the closing angle of the blades of the shears in a simple way based on the displacement of the actuating lever so that an excellent feedback is provided.

Advantageously, the guide member of the actuating member is guided in a guide structure which is positioned within the housing of the shears. In this context, the guide structure can be formed immediately in the housing or can be embodied in a guide structure body that is inserted into the housing.

The guide member is guided between a first guide path and a second guide path that are positioned opposite each other and extend along the straight actuating travel path of the actuating member. In this connection, the configuration is such that the guide member is positioned with play between the guide paths and the guide member has a first end that is supported only with a first support member on the first guide path and a second end that is supported only with a second guide member at the second guide path. In this way, while an easy guiding action is provided, a sufficiently precise support action of the actuating lever or member is ensured wherein even soiling can hardly impair the easy movement of the axially slidable guide member.

The support members which are disposed at the ends of the guide member are positioned such that the first support member is positioned on a first longitudinal side of the guide member relative a longitudinal center axis of the guide member and the second support member is positioned on the opposite side of the guide member relative to the longitudinal center axis.

A good and easy movement is achieved when the support members are rollers, cylinders or similar rolling bodies. Also, the support can be realized by means of a movable ball or the like.

In a further embodiment of the invention, at one end of the guide member a restoring force is introduced which forces the actuating member into its initial position. The spring force ensures also that the support members of the guide member are resting on the respective guide surfaces. For this purpose, the point of force introduction of the restoring force is provided at a spacing to the longitudinal center axis of the guide member so that a torque acting about the first support point is applied and the second support member is thereby also resting without play on the second guide path.

The actuating member is monolithically formed together with the guide member that is guided in a translatory (linear) motion in the guide structure, wherein the actuating member in a further embodiment of the invention projects through a slot in the guide structure and wherein the beginning and the end of the slot form a forward stop and a rearward stop, respectively, for the displacement travel of the actuating member.

Further features of the invention result from the further claims, the description, and the drawings, disclosing one embodiment of the invention in more detail.

### BRIEF DESCRIPTION OF THE DRAWING

FIG. 1 is a schematic illustration of electric shears.

FIG. 2 is a side view of the electric shears of FIG. 1 with device components schematically indicated within the housing.

FIG. 3 is a side view according to FIG. 2 showing the housing in the area of the actuating member in a partially open view.

FIG. 4 is a detail illustration of the open housing section with the actuating member according to FIG. 3.

FIG. 5 is a schematic diagram of the opening angle of the blades relative to the actuating travel of the actuating member.

### DESCRIPTION OF THE PREFERRED EMBODIMENTS

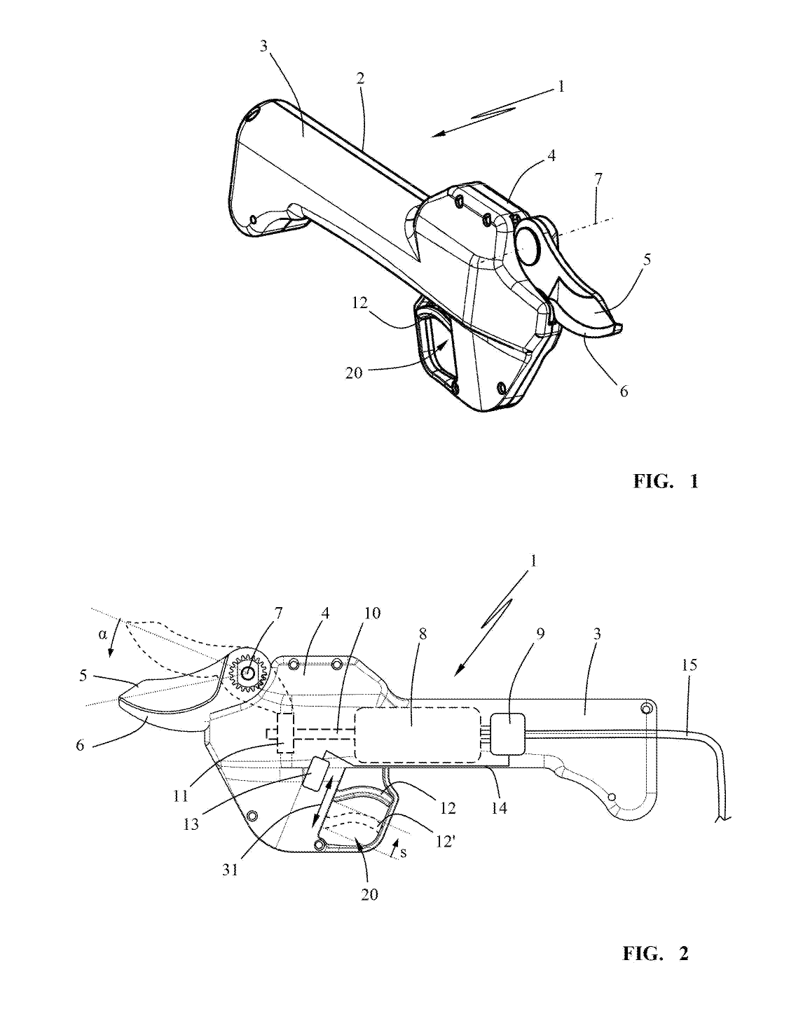

The electric shears illustrated in FIG. 1 are embodied as pruning shears 1 for branches or vines, or gardening shears or the like. Such shears 1 are used, for example, in gardens or vineyards. The shears 1 are substantially comprised of a housing 3 which is simultaneously designed as a handle. In the area of the head 4, the blades 5 and 6 of the shears are provided. In the illustrated embodiment, the blade 6 is stationary while the blade 5 is pivoted relative to the blade 6 about the blade axis 7.

The (pruning) shears 1 are electric shears expediently supplied with electric power by a non-illustrated battery pack. As can be seen in the side view of FIG. 2, in the housing 3 of the shears 1 an electric drive motor 8 is disposed which is controlled by control unit 9. The motor shaft 10 operates a spindle; a drive member 11 is screwed onto the spindle. The drive member 11 is connected with the movable blade 5 so that the blades 5 and 6 are opened in a first rotational direction of the electric drive motor 8 and are closed in the second rotational direction of the electric drive motor 8. The shears 1 held by the operator are actuated by suppressing an actuating member 12. For sensing the position of the actuating member 12, a position sensor 13 is provided, preferably within the housing 3 of the shears 2, and its electric control signal represents the mechanical position of the manual actuating member 12.

The electric control signal is transmitted by signal line 14 to the control unit 9 which, in accordance with the electric control signal, controls the electric drive motor 8. The electric power for operating the drive motor 8 is supplied to the control unit 9 by means of electric power cable 15, for example, from a battery pack that is carried by the user on his body. It may be expedient to provide a receptacle for a battery pack in the housing 3 of the shears I.

In FIG. 2, the position of the actuating member 12 with closed blades 5 and 6 is illustrated in solid lines. The dashed lines indicate the open blades 5 and 6; in this open position of the actuating member is the indicated position 12′. In accordance with the travel s of the translatory displacement of the actuating member 12, the movable blade 5 is adjusted by closing angle a. A direct electromechanical coupling is provided between the actuating member 12 and the blade 5.

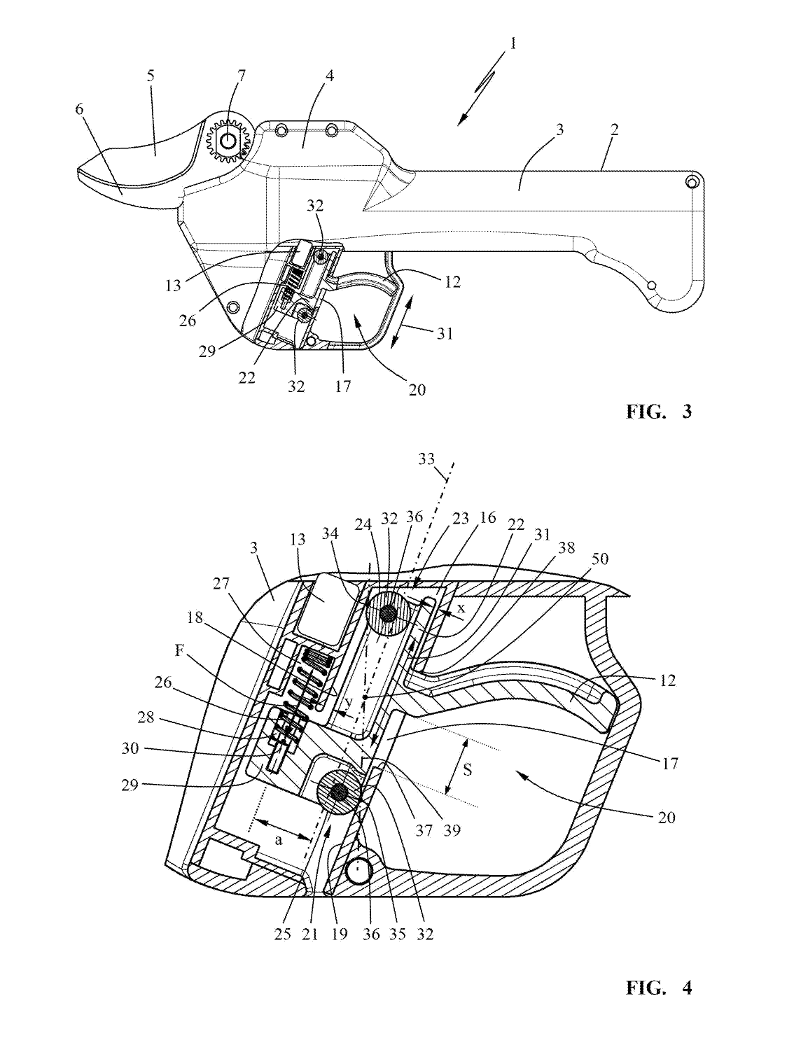

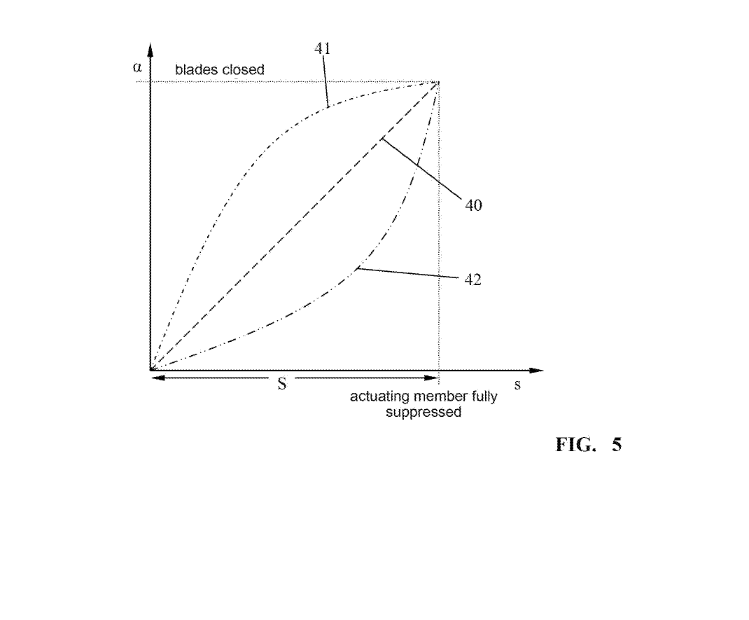

As can be seen in the illustrations of FIGS. 3 and 4, the actuating member 12 is connected with a guide member 22 which is guided in a guide structure 16 in the housing 3 of the shears 1. The actuating member 12 is embodied as a finger lever and penetrates a slot 17 of the housing 3. The actuating member 12 is attached approximately centrally to the elongate guide member 22. Preferably, the guide member 22 and the actuating member 12 are of a monolithic configuration and form an actuator 20.

The guide structure 16 is formed as a chamber that is separate from the remaining portion of the housing 3 and surrounds protectively the guide member 22. The actuating member 12 and the guide member 22 form the actuator 20 which is to be manually operated by the operator for opening and closing the blades 5, 6 of the shears 1.

As illustrated in the detail illustration of FIG. 4, the guide structure 16 has a first guide path 18 and a second guide path 19. The second guide path 19 is positioned on one flat side of the guide member 22 where the actuating member 12 is located and has a slot 17 which is penetrated by the actuating member 12. The first guide path 18 is positioned opposite the second guide path 19 on the other side of the guide member 22. Both guide paths 18, 19 are embodied expediently so as to be plane-parallel. It may be expedient to provide one of the guide paths 18, 19 with a guide groove, a guide bead or the like for guiding the guide member 22.

The guide member 22 is positioned with play x or y relative to the guide paths 18 and 19, respectively. For supporting the guide member 22, its ends 21 and 23 are provided with support members 24 and 25. On the end 23 of the guide member 22, there is a first support member 24 which is supported on the first guide path 18. On the other end 21 of the guide member 22, the second support member 25 is provided which is supported on the second guide path 19. The actuator 20, which is approximately T-shaped in a side view, is thus positioned with play within the guide structure 16 and is supported at its ends by the support member 24 or 25, respectively, on the correlated guide path 18 or 19.

In order to return the actuator member 20 into its initial position (in the FIGS. 3 and 4 the actuator 20 has been actuated and is in position at the terminal stop), a restoring spring 26 is provided which is expediently a coil spring. The restoring spring 26 is secured with a first end in a receptacle 27 of the housing 3 and is positioned with its second end in a counter receptacle 28 of the guide member 22. The counter receptacle 28 is formed in a projection 29 of the guide member 22 so that the guide member 22, in a side view, has approximately the shape of a horizontally positioned L. The projection 29 is positioned at the end 21 of the guide member 22 above the second support member 25 wherein the point of force introduction 30 of the restoring force F is spaced at a spacing a relative to the longitudinal center axis 33 of the guide member 22. The restoring force F exerts a torque (F×a) about the second support member 25 on the guide member 22. In this way, it is achieved that, on the one hand, the second support member 25 is pressed onto its correlated second guide path 19 and, on the other hand, the first support member 24 is pressed onto its correlated first guide path 18 due to the acting torque (F×a). Despite the generous play x and y of the lateral surfaces of the guide member 22 relative to the guide paths 18 and 19, due to the acting restoring force F of the restoring spring 26, a play-free guiding action of the guide member 22 and thus of the actuator 20 is achieved upon translatory (linear) motion along the straight actuating travel path 31.

The first support member 24, relative to the longitudinal center axis 33 of the guide member 22, is provided on a first side of the guide member 22 relative to the longitudinal center axis 33 while the second support member 25 is positioned on the second side of the guide member 22 relative to the longitudinal center axis 33. The support members 24 and 25 are advantageously embodied as rollers 32 or cylinders which rotate about an axle 36 which is provided within the guide member 22.

The support members 24 and 25 respectively act at support point 34 or 35 on the guide paths 18 and 19 according to a side view of FIG. 4. The connecting line 39 of the support points 34 and 35 intersects the longitudinal center axis 33 approximately at the longitudinal center 50 of the guide member 22. In the area of the longitudinal center 50, the actuating member 12 is mounted on the guide member 22.

The actuator 20 is thus guided within the guide structure 16 to carry out a translatory (linear) motion when suppressing the actuating member 12 wherein the length of the guide member 22 extends along the straight actuating travel path 31. When the operator releases the actuating member 12, the guide member 22, together with the actuating member 12, is moved by the restoring force F in the direction of the opposite end 21 until the actuating member 12 contacts the forward stop 37 of the slot 17 (dashed-line illustration in FIG. 2). In this position, the blades 5 and 6 are in the open position shown in FIG. 2 in dashed lines. The total stroke S of the actuator 20 or of the actuating member 12 is thus directly related to the closing angle a of the blades 5 and 6. When the actuating member 12 is suppressed by the operator, a displacement travel s results which has correlated therewith a corresponding closing angle a of the blades 5 and 6 assigned by means of the control unit 9. As shown in the schematic illustration in FIG. 5, on the x-axis the displacement travel s and on the y-axis the closing angle a are plotted. Depending on the configuration of the control unit 9, the translatory (linear) displacement travel s, i.e., the actuating travel, can be designed to be directly proportional to the closing angle a of the blades 5 and 6, as indicated by the straight line 40.

It may be advantageous that, when starting a cutting operation, a faster closure of the blades 5 and 6 is carried out, as indicated by the curve 41. Expedient is also the relation between the displacement travel (actuating travel) s and the closing angle a according to curve 42, where at the end of the total stroke S a faster closing action of the blades 5 and 6 is generated.

Important for the configuration of the straight line 40 or of the curves 41 and 42 is the subjective sensation experienced by the operator. Due to the translatory (linear) motion of the actuator 20 it is ensured that the operator can perform a sensitive control of the blades, wherein the closing angle a of the blades is approximately proportional to the position of the actuating member 12. When the operator suppresses the actuating member 12, the drive motor 8 is moved by the control unit 9 in a first rotational direction and the blade 5 closes. When the user releases the actuating member 12, it is returned by the restoring spring 26 and the drive motor 8 is rotated in the opposite rotational direction so that the blade 5 opens.

The mechanical position of the manual actuating member 12 of the shears 1 must be converted into an electric control signal which can be processed by the control unit 9. For this purpose, the position sensor 13 is indicated which senses the position of the guide member 22 relative to the position sensor 13 and outputs an appropriate output signal. The position sensor 13 can be a contactless sensor, for example, an inductive, capacitive or electromagnetic sensor (Hall sensor). It may also be expedient to actuate with the guide member 22 a sliding contact or the like in order to obtain an electric position signal of the guide member 22.

The specification incorporates by reference the entire disclosure of German priority document 10 2012 024 838.5 having a filing date of De. 19, 2012.

While specific embodiments of the invention have been shown and described in detail to illustrate the inventive principles, it will be understood that the invention may be embodied otherwise without departing from such principles.

What is claimed is:

1. Electrical shears comprising:
a housing;
an electric drive motor arranged in the housing;
a motor shaft connected to the drive motor;
blades, wherein at least one of the blades is connected to the motor shaft, wherein the motor shaft acts on the at least one blade for opening or closing the blades;
a manual actuating member, wherein the manual actuating member comprises a guide member and is adapted to be guided in a translatory motion, wherein the guide member has a length extending in a direction of a straight actuating travel path of the manual actuating member;
a control unit, wherein the drive motor, as a function of an electric control signal, is controlled by the electronic control unit and wherein the electric control signal represents a mechanical position of the manual actuating member.

2. The shears according to claim 1, wherein an actuating travel of the manual actuating member along the translatory actuating travel path and a closing angle of the blades are dependent on each other.

3. The shears according to claim 2, wherein the translatory actuating travel is proportional to the closing angle.

4. The shears according to claim 1, further comprising a guide structure, wherein the guide member is disposed in the guide structure which is arranged within the housing.

5. The shears according to claim 1, comprising a first guide path and a second guide path positioned opposite each other and extending in a direction of the actuating travel path, wherein the guide member is guided on the first and second guide paths.

6. The shears according to claim 5, wherein the guide member is positioned with play between the first and second guide paths, wherein the guide member has a first end provided with a first support member and is supported with the first support member on the first guide path, wherein the guide member has a second end provided with a second support member and is supported with the second support member on the second guide path.

7. The shears according to claim 6, wherein the guide member has a longitudinal center axis, wherein the first support member is positioned on a first side of the guide member relative to the longitudinal center axis and the second support member is positioned on the opposite side of the guide member relative to the longitudinal center axis.

8. The shears according to claim 6, wherein the support member is a roller.

9. The shears according to claim 1, wherein a restoring force is introduced at one end of the guide member into the guide member.

10. The shears according to claim 9, wherein a point of force introduction of the restoring force is positioned at a spacing relative to a longitudinal center axis of the guide member.

11. The shears according to claim 1, wherein the actuating member and the guide member together form a monolithic part.

12. The shears according to claim 11, further comprising a guide structure with a slot, wherein the guide member is guided in the guide structure and wherein the actuating member projects through the slot in the guide structure out of the guide structure, and wherein the slot has a beginning and an end, wherein the beginning and the end form a forward stop and a rearward stop for a translatory actuating travel of the actuating member in the direction of the straight actuating travel path.
